(19) United States
(12) Patent Application Publication
(10) Pub. No.: US 2023/0010673 A1
(43) Pub. Date: Jan. 12, 2023

(54) METHOD AND SYSTEM FOR JOBSITE MONITORING

(71) Applicant: JPMorgan Chase Bank, N.A., New York, NY (US)

(72) Inventors: Satish JONNAVITHULA, Plainsboro, NJ (US); Arun Abhishek JONNAVITHULA, Plainsboro, NJ (US); Ketan PATEL, Monmouth Junction, NJ (US)

(73) Assignee: JPMorgan Chase Bank, N.A., New York, NY (US)

(21) Appl. No.: 17/806,421

(22) Filed: Jun. 10, 2022

Related U.S. Application Data
(60) Provisional application No. 63/219,190, filed on Jul. 7, 2021.

(51) Int. Cl. G06Q 10/06; G08B 21/18; G08B 21/22

(52) U.S. Cl. CPC G06Q 10/063; G08B 21/185; G08B 21/22; G08B 21/182

(57) ABSTRACT

A method for facilitating remote jobsite monitoring is provided. The method includes receiving data from a sensor device; parsing the data to generate a data set that corresponds to the sensor device; determining a threshold violation by comparing the data set to a corresponding predetermined threshold value; generating an alert that includes information corresponding to the threshold violation; identifying an external device and a corresponding mobile communication protocol based on at least one from among a predetermined setting and the threshold violation; and transmitting, via the identified mobile communication protocol, the alert to the identified external device.

### CROSS-REFERENCE TO RELATED APPLICATIONS

This application claims the benefit of U.S. Provisional Patent Application Ser. No. 63/219,190, filed Jul. 7, 2021, which is hereby incorporated by reference in its entirety.

### BACKGROUND

### 1. Field of the Disclosure

This technology generally relates to methods and systems for jobsite monitoring, and more particularly to methods and systems for facilitating jobsite monitoring by using edge computing devices as well as cellular internet of things (IoT) devices to identify, report, and document threshold violations.

### 2. Background Information

Many business entities operate jobsites such as, for example, remote residential construction sites where internet connectivity and power supplies are limited, sporadic, and/or unavailable. The jobsites are often inadequately connected to the internet and the power for extended periods of time. Historically, conventional techniques for monitoring the jobsites have resulted in varying degrees of success with respect to effective capturing of jobsite transgressions and timely notification of the captured jobsite transgressions.

One drawback of using conventional techniques for monitoring the jobsites is that in many instances, monitoring facilities such as, for example, security cameras, smoke sensors, gas leak sensors, humidity sensors, and temperature sensors are not available due to the inadequate internet connectivity and power supplies. As a result, the jobsites are ineffectively monitored for long periods of time until infrastructures for internet and power are available. In addition, remediation actions to resolve the captured jobsite transgressions may be delayed due to the lack of timely notifications to responsible parties.

Therefore, there is a need to facilitate jobsite monitoring by using power grid independent, edge computing devices as well as cellular internet of things (IoT) devices to identify, report, and document threshold violations.

### SUMMARY

The present disclosure, through one or more of its various aspects, embodiments, and/or specific features or sub-components, provides, inter alia, various systems, servers, devices, methods, media, programs, and platforms for facilitating jobsite monitoring by using edge computing devices as well as cellular internet of things (IoT) devices to identify, report, and document threshold violations.

According to an aspect of the present disclosure, a method for facilitating jobsite monitoring is provided. The method is implemented by at least one processor. The method may include receiving data from at least one sensor device; parsing the data to generate at least one data set that corresponds to each of the at least one sensor device; determining at least one threshold violation by comparing the at least one data set to a corresponding predetermined threshold value; generating at least one alert based on a result of the determining, the at least one alert may include information that corresponds to the at least one threshold violation; identifying at least one external device and at least one corresponding mobile communication protocol based on at least one from among a predetermined setting and the at least one threshold violation; and transmitting, via the at least one identified mobile communication protocol, the at least one alert to the at least one identified external device.

In accordance with an exemplary embodiment, the data may include at least one from among motion data, temperature data, humidity data, gas dispersion data, image data, and video data that are captured by the at least one sensor device, the at least one sensor device may include at least one from among a temperature sensor, a humidity sensor, a gas dispersion sensor, and an image sensor.

In accordance with an exemplary embodiment, the method may further include persisting, in a repository, the at least one data set together with the information that corresponds to the at least one threshold violation; determining whether the persisted at least one data set satisfies at least one predetermined criterion; and transmitting, via a communication interface, the persisted at least one data set and the information to a remote storage repository when the at least one predetermined criterion is satisfied.

In accordance with an exemplary embodiment, the at least one predetermined criterion may include at least one from among a motion detection criterion, a point of interest criterion, an object detection criterion, and a person detection criterion.

In accordance with an exemplary embodiment, the method may further include inspecting the persisted at least one data set to detect at least one error, the at least one error may correspond to at least one from among a corrupted data error, a distorted data error, and a noisy data error; and initiating at least one corrective action to resolve the detected at least one error, the at least one corrective action may include at least one from among a filtering action, a deleting action, and a reconstructing action.

In accordance with an exemplary embodiment, the method may further include receiving, via a graphical user interface, at least one request from at least one authorized device, the at least one request may include at least one textual command; parsing the at least one textual command to identify at least one requested data set that corresponds to the at least one textual command; determining a storage location of the identified at least one requested data set; and initiating a transmission of the identified at least one requested data set from the determined storage location to the at least one authorized device.

In accordance with an exemplary embodiment, the data may be received from the at least one sensor device via at least one edge computing device that is locally operated together with the at least one sensor device.

In accordance with an exemplary embodiment, the at least one edge computing device may include a power source that enables operation of the at least one edge computing device without a connection to a power grid and an energy collector that replenishes the power source, the energy collector may include at least one photo-voltaic module.

In accordance with an exemplary embodiment, to generate the at least one data set, the method may further include identifying, from the data, metadata that corresponds to the generated at least one data set, the metadata may include a current time and a current date; and associating the metadata with the corresponding at least one data set.

According to an aspect of the present disclosure, a computing device configured to implement an execution of a method for facilitating jobsite monitoring is disclosed. The computing device including a processor; a memory; and a communication interface coupled to each of the processor and the memory, wherein the processor may be configured to receive data from at least one sensor device; parse the data to generate at least one data set that corresponds to each of the at least one sensor device; determine at least one threshold violation by comparing the at least one data set to a corresponding predetermined threshold value; generate at least one alert based on a result of the determining, the at least one alert may include information that corresponds to the at least one threshold violation; identify at least one external device and at least one corresponding mobile communication protocol based on at least one from among a predetermined setting and the at least one threshold violation; and transmit, via the at least one identified mobile communication protocol, the at least one alert to the at least one identified external device.

In accordance with an exemplary embodiment, the data may include at least one from among motion data, temperature data, humidity data, gas dispersion data, image data, and video data that are captured by the at least one sensor device, the at least one sensor device may include at least one from among a temperature sensor, a humidity sensor, a gas dispersion sensor, and an image sensor.

In accordance with an exemplary embodiment, the processor may be further configured to persist, in a repository, the at least one data set together with the information that corresponds to the at least one threshold violation; determine whether the persisted at least one data set satisfies at least one predetermined criterion; and transmit, via the communication interface, the persisted at least one data set and the information to a remote storage repository when the at least one predetermined criterion is satisfied.

In accordance with an exemplary embodiment, the at least one predetermined criterion may include at least one from among a motion detection criterion, a point of interest criterion, an object detection criterion, and a person detection criterion.

In accordance with an exemplary embodiment, the processor may be further configured to inspect the persisted at least one data set to detect at least one error, the at least one error may correspond to at least one from among a corrupted data error, a distorted data error, and noisy data error; and initiate at least one corrective action to resolve the detected at least one error, the at least one corrective action may include at least one from among a filtering action, a deleting action, and a reconstructing action.

In accordance with an exemplary embodiment, the processor may be further configured to receive, via a graphical user interface, at least one request from at least one authorized device, the at least one request may include at least one textual command; parse the at least one textual command to identify at least one requested data set that corresponds to the at least one textual command; determine a storage location of the identified at least one requested data set; and initiate a transmission of the identified at least one requested data set from the determined storage location to the at least one authorized device.

In accordance with an exemplary embodiment, the processor may be further configured to receive the data from the at least one sensor device via at least one edge computing device that is locally operated together with the at least one sensor device.

In accordance with an exemplary embodiment, the at least one edge computing device may include a power source that enables operation of the at least one edge computing device without a connection to a power grid and an energy collector that replenishes the power source, the energy collector may include at least one photo-voltaic module.

In accordance with an exemplary embodiment, to generate the at least one data set, the processor may be further configured to identify, from the data, metadata that corresponds to the generated at least one data set, the metadata may include a current time and a current date; and associate the metadata with the corresponding at least one data set.

According to an aspect of the present disclosure, a non-transitory computer readable storage medium storing instructions for facilitating jobsite monitoring is disclosed. The storage medium including executable code which, when executed by a processor, may cause the processor to receive data from at least one sensor device; parse the data to generate at least one data set that corresponds to each of the at least one sensor device; determine at least one threshold violation by comparing the at least one data set to a corresponding predetermined threshold value; generate at least one alert based on a result of the determining, the at least one alert may include information that corresponds to the at least one threshold violation; identify at least one external device and at least one corresponding mobile communication protocol based on at least one from among a predetermined setting and the at least one threshold violation; and transmit, via the at least one identified mobile communication protocol, the at least one alert to the at least one identified external device.

In accordance with an exemplary embodiment, the data may include at least one from among motion data, temperature data, humidity data, gas dispersion data, image data, and video data that are captured by the at least one sensor device, the at least one sensor device may include at least one from among a temperature sensor, a humidity sensor, a gas dispersion sensor, and an image sensor.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating jobsite monitoring by using edge computing devices as well as cellular internet of things (IoT) devices to identify, report, and document threshold violations.

FIG. 4 is a flowchart of an exemplary process for implementing a method for facilitating jobsite monitoring by using edge computing devices as well as cellular IoT devices to identify, report, and document threshold violations.

FIG. 5 is a diagram of an exemplary system for implementing a method for facilitating jobsite monitoring by using edge computing devices as well as cellular IoT devices to identify, report, and document threshold violations.

FIG. 6 is a screen shot that illustrates a graphical user interface for requesting images that is usable for implementing a method for facilitating jobsite monitoring by using edge computing devices as well as cellular IoT devices to identify, report, and document threshold violations, according to an exemplary embodiment.

FIG. 7 is a screen shot that illustrates a graphical user interface for sensor data notification that is usable for implementing a method for facilitating jobsite monitoring by using edge computing devices as well as cellular IoT devices to identify, report, and document threshold violations, according to an exemplary embodiment.

FIG. 8 is a screen shot that illustrates a graphical user interface for image notification that is usable for implementing a method for facilitating jobsite monitoring by using edge computing devices as well as cellular IoT devices to identify, report, and document threshold violations, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

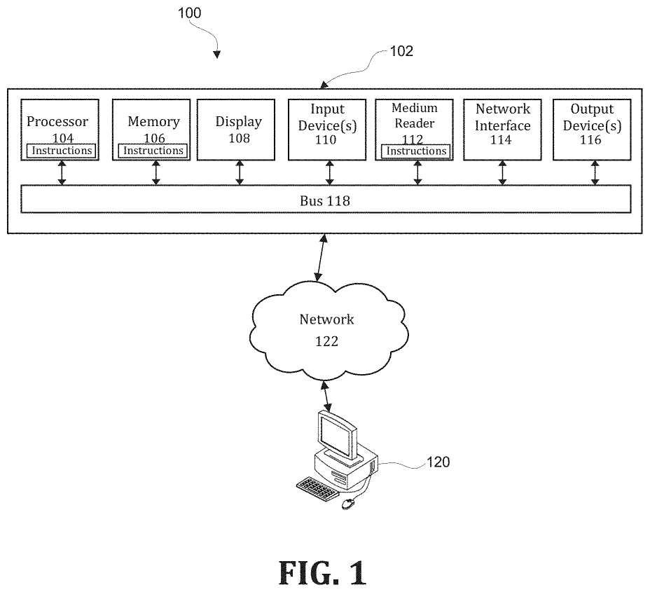

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating jobsite monitoring by using edge computing devices as well as cellular internet of things (IoT) devices to identify, report, and document threshold violations.

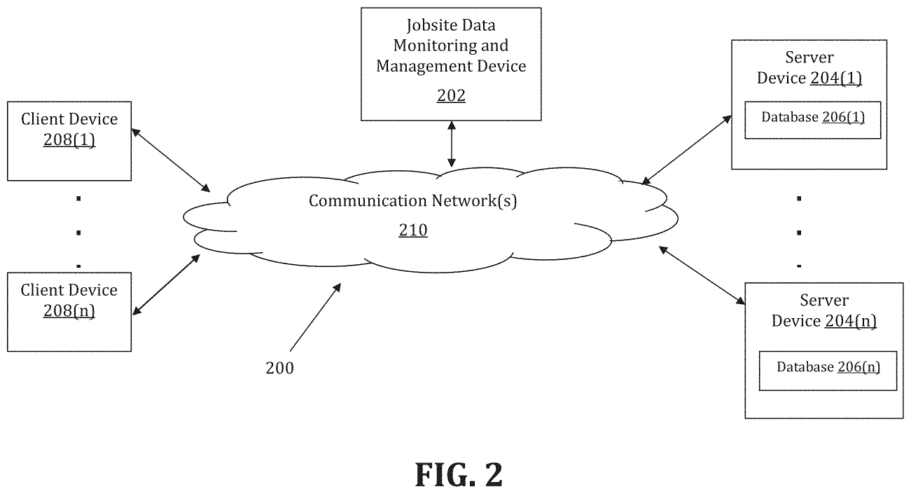

Referring to FIG. 2, a schematic of an exemplary network environment 200 for implementing a method for facilitating jobsite monitoring by using edge computing devices as well as cellular IoT devices to identify, report, and document threshold violations is illustrated. In an exemplary embodiment, the method is executable on any networked computer platform, such as, for example, a personal computer (PC).

The method for facilitating jobsite monitoring by using edge computing devices as well as cellular IoT devices to identify, report, and document threshold violations may be implemented by a Jobsite Data Monitoring and Management (JDMM) device 202. The JDMM device 202 may be the same or similar to the computer system 102 as described with respect to FIG. 1. The JDMM device 202 may store one or more applications that can include executable instructions that, when executed by the JDMM device 202, cause the JDMM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the JDMM device 202 itself, may be located in virtual server(s) running in a cloud-based computing environment rather than being tied to one or more specific physical network computing devices. Also, the application(s) may be running in one or more virtual machines (VMs) executing on the JDMM device 202. Additionally, in one or more embodiments of this technology, virtual machine(s) running on the JDMM device 202 may be managed or supervised by a hypervisor.

In the network environment 200 of FIG. 2, the JDMM device 202 is coupled to a plurality of server devices 204(1)-204(n) that hosts a plurality of databases 206(1)-206(n), and also to a plurality of client devices 208(1)-208(n) via communication network(s) 210. A communication interface of the JDMM device 202, such as the network interface 114 of the computer system 102 of FIG. 1, operatively couples and communicates between the JDMM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the JDMM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and JDMM devices that efficiently implement a method for facilitating jobsite monitoring by using edge computing devices as well as cellular IoT devices to identify, report, and document threshold violations.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The JDMM device 202 may be a standalone device or integrated with one or more other devices or apparatuses, such as one or more of the server devices 204(1)-204(n), for example. In one particular example, the JDMM device 202 may include or be hosted by one of the server devices 204(1)-204(n), and other arrangements are also possible. Moreover, one or more of the devices of the JDMM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the JDMM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to sensor data, parsed data, generated data sets, threshold value data, alert data, mobile communication protocol data, criterion data, and error data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the JDMM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the JDMM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the JDMM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the JDMM device 202, the server devices 204(1)-204(n), or the client devices 208(1)-208(n), for example, may be configured to operate as virtual instances on the same physical machine. In other words, one or more of the JDMM device 202, the server devices 204(1)-204(n), or the client devices 208(1)-208(n) may operate on the same physical device rather than as separate devices communicating through communication network(s) 210. Additionally, there may be more or fewer JDMM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

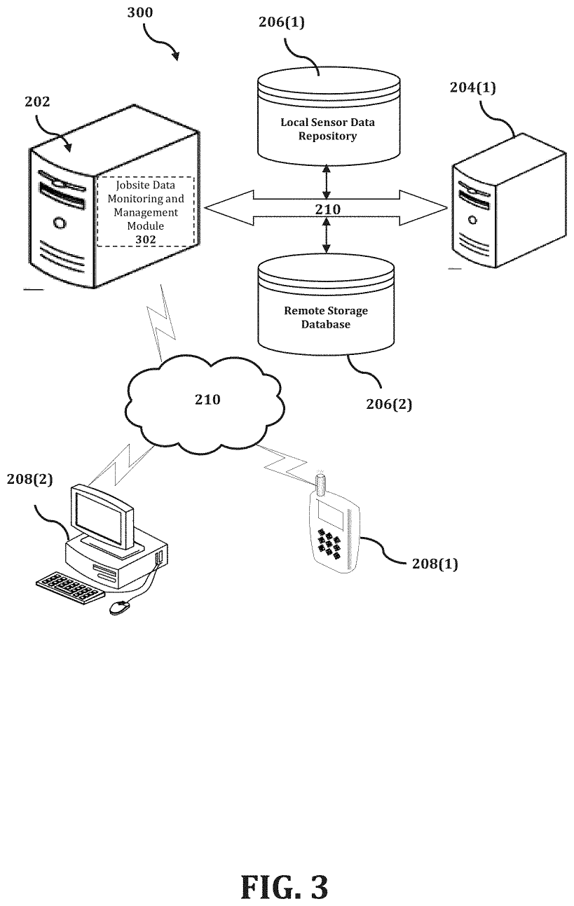

The JDMM device 202 is described and shown in FIG. 3 as including a jobsite data monitoring and management module 302, although it may include other rules, policies, modules, databases, or applications, for example. As will be described below, the jobsite data monitoring and management module 302 is configured to implement a method for facilitating jobsite monitoring by using edge computing devices as well as cellular IoT devices to identify, report, and document threshold violations.

An exemplary process 300 for implementing a mechanism for facilitating jobsite monitoring by using edge computing devices as well as cellular IoT devices to identify, report, and document threshold violations by utilizing the network environment of FIG. 2 is shown as being executed in FIG. 3. Specifically, a first client device 208(1) and a second client device 208(2) are illustrated as being in communication with JDMM device 202. In this regard, the first client device 208(1) and the second client device 208(2) may be “clients” of the JDMM device 202 and are described herein as such. Nevertheless, it is to be known and understood that the first client device 208(1) and/or the second client device 208(2) need not necessarily be “clients” of the JDMM device 202, or any entity described in association therewith herein. Any additional or alternative relationship may exist between either or both of the first client device 208(1) and the second client device 208(2) and the JDMM device 202, or no relationship may exist.

Further, JDMM device 202 is illustrated as being able to access a local sensor data repository 206(1) and a remote storage database 206(2). The jobsite data monitoring and management module 302 may be configured to access these databases for implementing a method for facilitating jobsite monitoring by using edge computing devices as well as cellular IoT devices to identify, report, and document threshold violations.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the JDMM device 202 via broadband or cellular communication. Of course, these embodiments are merely exemplary and are not limiting or exhaustive.

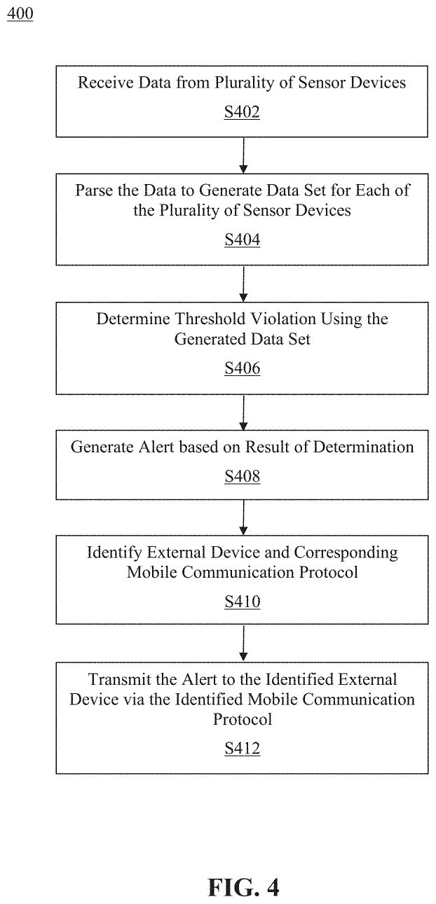

Upon being started, the jobsite data monitoring and management module 302 executes a process for facilitating jobsite monitoring by using edge computing devices as well as cellular IoT devices to identify, report, and document threshold violations. An exemplary process for facilitating jobsite monitoring by using edge computing devices as well as cellular IoT devices to identify, report, and document threshold violations is generally indicated at flowchart 400 in FIG. 4.

In the process 400 of FIG. 4, at step S402, data may be received from sensor devices. The data may include units of information that are collected by each of the sensor devices. In an exemplary embodiment, the data may include information in a raw data format that has not been processed for use. For example, the data may be received directly from the sensor devices without prior processing. In another exemplary embodiment, the data may include information in a data format that has been processed for use. For example, the sensor devices may preprocess image data according to an image compression algorithm to reduce file size.

In another exemplary embodiment, the data may include at least one from among motion data, temperature data, humidity data, gas dispersion data, image data, and video data that are captured by the sensor devices. The data may include information in a machine-readable format as well as information in a human-readable format. In another exemplary embodiment, the sensor devices may include at least one from among a temperature sensor, a humidity sensor, a gas dispersion sensor, and an image sensor. The sensor devices may be connected to a monitoring device directly via a physical connection, wirelessly via a wireless communication protocol such as, for example, a BLUETOOTH protocol, as well as wirelessly via a light-weight messaging protocol such as, for example, a message queuing telemetry transport (MQTT) protocol.

In another exemplary embodiment, the monitoring device may include locally operated computing devices in an edge computing paradigm. The locally operated computing devices may include single-board computers such as, for example, a RASPBERRY PI that facilitates computational, storage, and communication tasks. In another exemplary embodiment, the monitoring device may include a power source such as, for example, a battery which enables operation of the monitoring device without a connection to a power grid. The monitoring device may replenish the power source via an energy collector such as, for example, a photo-voltaic module that is connected to the monitoring device. In another exemplary embodiment, the monitoring device may include a communication module such as, for example, an antenna which enables external communication via a communication standard such as, for example, a cellular communication standard. The monitoring device may utilize a point-to-point (PTP) communication protocol to communicate with connected endpoints and/or nodes.

At step S404, the data may be parsed to facilitate the generation of a structured data set. The structured data set may correspond to each of the sensor devices. In an exemplary embodiment, the data may be parsed to facilitate data mapping based on a predetermined data model. For example, temperature data may be mapped for storage in a tabular format. In another exemplary embodiment, corresponding metadata may be associated with the structured data set. For example, metadata such as a current time and a current date may be associated with corresponding temperature data. In another exemplary embodiment, the data may be parsed to facilitate data pattern analysis. For example, software algorithms may continually compare parsed image data to detect changes in an image to infer motion.

At step S406, a threshold violation may be determined by comparing the structured data set to a corresponding predetermined threshold value. In an exemplary embodiment, the predetermined threshold value may relate to a numerical amount that is denoted by an algebraic term. The predetermined threshold value may include a magnitude, a quantity, and a number. For example, the predetermined threshold value for the acceptable dispersion of combustible gasses in a given volume may correspond to a maximum safe dispersion amount. In another exemplary embodiment, the predetermined threshold value may relate to a particular condition. For example, the predetermined threshold value may correspond to a detection of motion in a series of images.

In another exemplary embodiment, a severity level may be assigned based on the threshold that has been violated. The severity level may be predetermined for each of the threshold violations and may include a high severity level, a medium severity level, and a low severity level. For example, when a gas dispersion threshold has been violated resulting in a combustion risk, a high severity level may be associated with the threshold violation. In another exemplary embodiment, the severity level may be determined based on metadata that is associated with the structured data set. For example, a motion detected during daytime may be assigned a lower severity level than a motion that has been detected at night.

At step S408, an alert may be generated based on a result of the determining. The alert may include information that corresponds to the threshold violation. In an exemplary embodiment, the alert may be generated when a threshold violation has been determined. Information corresponding to the threshold violation may be compiled and included together with the alert. For example, when motion has been detected, information such as time, date, and severity level may be compiled together with image data and appended to the generated alert.

At step S410, an external device and a corresponding mobile communication protocol may be identified based on at least one from among a predetermined setting and the threshold violation. In an exemplary embodiment, the mobile communication protocol that corresponds to an external device may facilitate communication with the external device. For example, the mobile communication protocol may include Long-Term Evolution for Machine (LTE-M) communication standards as well as Narrow Band Internet of Things (NB-IoT) communication standards. In another exemplary embodiment, the mobile communication protocol may relate to a method for electronically communicating information such as, for example, via electronic mail and text message.

In another exemplary embodiment, the predetermined setting may relate to a user preference of the external device to be contacted. For example, a user may prefer that alerts are sent to a specific mobile device. In another exemplary embodiment, the threshold violation itself may dictate the external device that must be contacted. For example, a low priority threshold violation may only warrant an alert on a work computer while a high priority threshold violation may require that an alert be sent to a personal mobile device. Then, at step S412, the alert may be transmitted to the identified external device via the identified mobile communication protocol.

In another exemplary embodiment, the structured data set may be persisted together with the information that corresponds to the threshold violation in a repository. The repository may include locally connected computer storage devices such as, for example, computer hard drives. Then, a determination may be made as to whether the persisted structured data set satisfies a predetermined criterion. In another exemplary embodiment, the predetermined criterion may include at least one from among a motion detection criterion, a point of interest criterion, an object detection criterion, and a person detection criterion. The persisted structured data set and the information may be transmitted to a remote storage repository when the predetermined criterion is satisfied. For example, when a person has been detected in an image, the image may be transmitted to a remote storage device such as a cloud storage device to ensure that the image is not lost when the monitoring device is disabled. The persisted structured data set and the information may be transmitted via a communication interface consistent with disclosures in the present application.

In another exemplary embodiment, the persisted structured data set may be inspected to detect errors. The errors may correspond to at least one from among corrupted data errors, distorted data errors, and noisy data errors. When an error has been detected, a corrective action may be initiated to resolve the detected error. The corrective action may include at least one from among a filtering action, a deleting action, and a reconstructing action. In another exemplary embodiment, a user may be notified when the error is detected. The user notification may include information relating to the detected error and corresponding recommended corrective actions. In another exemplary embodiment, the corrective action may be initiated automatically without user input.

In another exemplary embodiment, a request is received via a graphical user interface from an authorized device. The request may include a textual command in a natural language such as, for example, an English language. The textual command may be parsed to identify a requested structured data set that corresponds to the textual command. Then, a storage location of the requested structured data set may be determined, and a transmission of the requested structured data set may be initiated from the storage location to the authorized device.

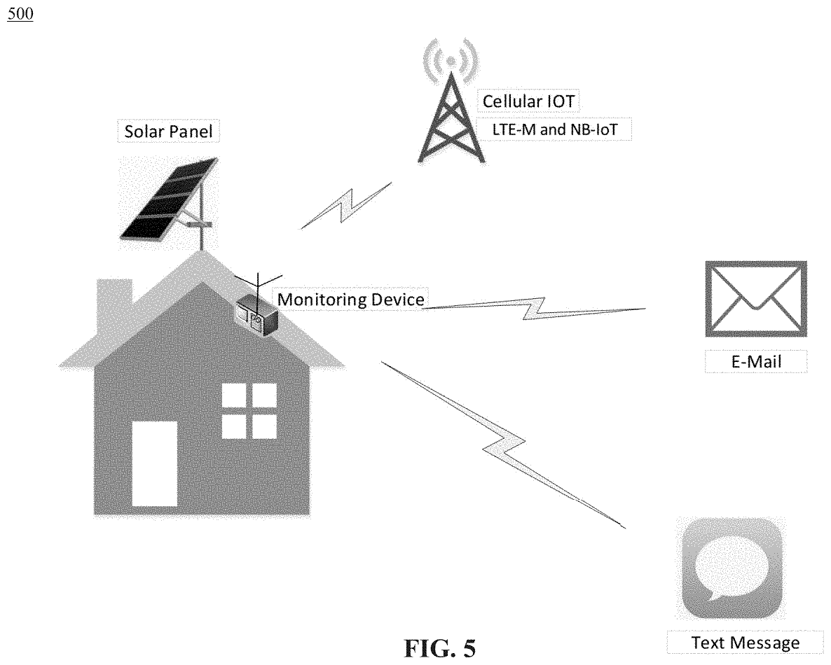

FIG. 5 is a diagram 500 of an exemplary system for implementing a method for facilitating jobsite monitoring by using edge computing devices as well as cellular IoT devices to identify, report, and document threshold violations. In FIG. 5, a monitoring device may be installed at a remote worksite that does not have consistent internet and power connectivity.

As illustrated in FIG. 5, the monitoring device may utilize solar panels to charge batteries that are used to provide power. In an exemplary embodiment, the monitoring device may include an antenna device that is used to connect with external computing devices via a cellular communication protocol such as, for example, a LTE-M communication protocol and a NB-IoT communication protocol. The monitoring device may communicate with external computing devices by using electronic communication techniques such as, for example, electronic mail and text message. The monitoring device may use the electronic communication techniques to communicate information consistent with disclosures in the present application.

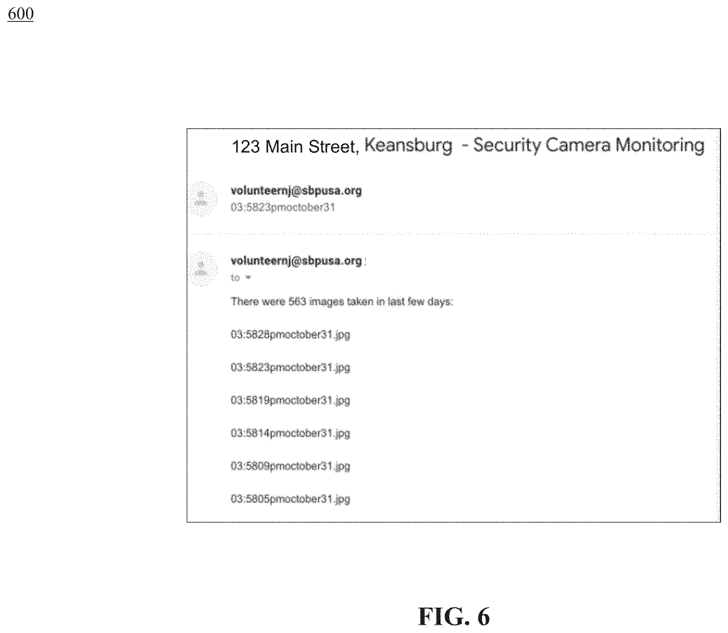

FIG. 6 is a screen shot 600 that illustrates a graphical user interface for requesting images that is usable for implementing a method for facilitating jobsite monitoring by using edge computing devices as well as cellular IoT devices to identify, report, and document threshold violations, according to an exemplary embodiment. In an exemplary embodiment, a user may communicate with a monitoring device via an electronic communication technique such as, for example, electronic mail and text message to request data. In FIG. 6, the monitoring device may respond to the user request via electronic mail.

As illustrated in FIG. 6, the response from the monitoring device may include a list of available information for retrieval such as, for example, a list of images that were taken in the past few days for the property at 123 Main Street. The user may respond with a request for a specific image from the list, which will then be provided for the user. As will be appreciated by a person of ordinary skill in the art, the provided image may be embedded in the response as well as remotely accessible via a hyperlink.

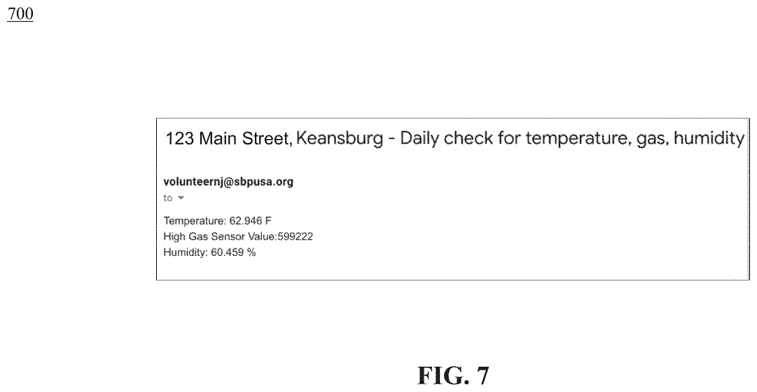

FIG. 7 is a screen shot 700 that illustrates a graphical user interface for sensor data notification that is usable for implementing a method for facilitating jobsite monitoring by using edge computing devices as well as cellular IoT devices to identify, report, and document threshold violations, according to an exemplary embodiment. In an exemplary embodiment, a user may be notified by a monitoring device when a threshold violation is detected. In FIG. 7, the monitoring device may notify the user of a threshold violation via electronic mail. As illustrated in FIG. 7, the notification from the monitoring device may include information such as, for example, a temperature value, a high gas sensor value, and a humidity value that correspond to the threshold violation.

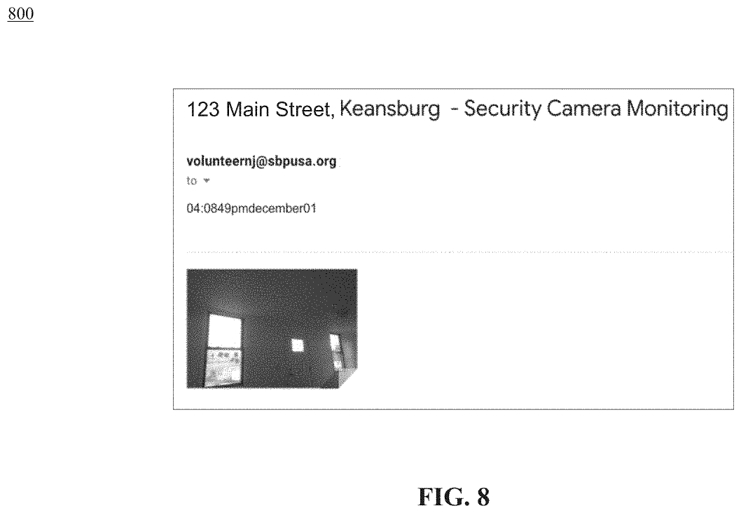

FIG. 8 is a screen shot 800 that illustrates a graphical user interface for image notification that is usable for implementing a method for facilitating jobsite monitoring by using edge computing devices as well as cellular IoT devices to identify, report, and document threshold violations, according to an exemplary embodiment. In an exemplary embodiment, a user may be notified by a monitoring device when a threshold violation such as, for example, a motion event is detected. In FIG. 8, the monitoring device may notify the user of a threshold violation via electronic mail. As illustrated in FIG. 8, the notification from the monitoring device may include information such as, for example, a captured image that corresponds to the threshold violation.

Accordingly, with this technology, an optimized process for facilitating jobsite monitoring by using edge computing devices as well as cellular IoT devices to identify, report, and document threshold violations is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating jobsite monitoring, the method being implemented by at least one processor, the method comprising:
receiving, by the at least one processor, data from at least one sensor device;
parsing, by the at least one processor, the data to generate at least one data set that corresponds to each of the at least one sensor device;
determining, by the at least one processor, at least one threshold violation by comparing the at least one data set to a corresponding predetermined threshold value;
generating, by the at least one processor, at least one alert based on a result of the determining, the at least one alert including information that corresponds to the at least one threshold violation;
identifying, by the at least one processor, at least one external device and at least one corresponding mobile communication protocol based on at least one from among a predetermined setting and the at least one threshold violation; and
transmitting, by the at least one processor via the at least one identified mobile communication protocol, the at least one alert to the at least one identified external device.

2. The method of claim 1, wherein the data includes at least one from among motion data, temperature data, humidity data, gas dispersion data, image data, and video data that are captured by the at least one sensor device, the at least one sensor device including at least one from among a temperature sensor, a humidity sensor, a gas dispersion sensor, and an image sensor.

3. The method of claim 1, further comprising:
persisting, by the at least one processor in a repository, the at least one data set together with the information that corresponds to the at least one threshold violation;
determining, by the at least one processor, whether the persisted at least one data set satisfies at least one predetermined criterion; and
transmitting, by the at least one processor via a communication interface, the persisted at least one data set and the information to a remote storage repository when the at least one predetermined criterion is satisfied.

4. The method of claim 3, wherein the at least one predetermined criterion includes at least one from among a motion detection criterion, a point of interest criterion, an object detection criterion, and a person detection criterion.

5. The method of claim 3, further comprising:
inspecting, by the at least one processor, the persisted at least one data set to detect at least one error, the at least one error corresponding to at least one from among a corrupted data error, a distorted data error, and noisy data error; and
initiating, by the at least one processor, at least one corrective action to resolve the detected at least one error, the at least one corrective action including at least one from among a filtering action, a deleting action, and a reconstructing action.

6. The method of claim 1, further comprising:
receiving, by the at least one processor via a graphical user interface, at least one request from at least one authorized device, the at least one request including at least one textual command;
parsing, by the at least one processor, the at least one textual command to identify at least one requested data set that corresponds to the at least one textual command;
determining, by the at least one processor, a storage location of the identified at least one requested data set; and
initiating, by the at least one processor, a transmission of the identified at least one requested data set from the determined storage location to the at least one authorized device.

7. The method of claim 1, wherein the data is received from the at least one sensor device via at least one edge computing device that is locally operated together with the at least one sensor device.

8. The method of claim 7, wherein the at least one edge computing device includes a power source that enables operation of the at least one edge computing device without a connection to a power grid and an energy collector that replenishes the power source, the energy collector including at least one photo-voltaic module.

9. The method of claim 1, wherein generating the at least one data set further comprises:
identifying, by the at least one processor from the data, metadata that corresponds to the generated at least one data set, the metadata including a current time and a current date; and
associating, by the at least one processor, the metadata with the corresponding at least one data set.

10. A computing device configured to implement an execution of a method for facilitating jobsite monitoring, the computing device comprising:
a processor;
a memory; and
a communication interface coupled to each of the processor and the memory, wherein the processor is configured to:
receive data from at least one sensor device;
parse the data to generate at least one data set that corresponds to each of the at least one sensor device;
determine at least one threshold violation by comparing the at least one data set to a corresponding predetermined threshold value;
generate at least one alert based on a result of the determining, the at least one alert including information that corresponds to the at least one threshold violation;
identify at least one external device and at least one corresponding mobile communication protocol based on at least one from among a predetermined setting and the at least one threshold violation; and
transmit, via the at least one identified mobile communication protocol, the at least one alert to the at least one identified external device.

11. The computing device of claim 10, wherein the data includes at least one from among motion data, temperature data, humidity data, gas dispersion data, image data, and video data that are captured by the at least one sensor device, the at least one sensor device including at least one from among a temperature sensor, a humidity sensor, a gas dispersion sensor, and an image sensor.

12. The computing device of claim 10, wherein the processor is further configured to:
persist, in a repository, the at least one data set together with the information that corresponds to the at least one threshold violation;
determine whether the persisted at least one data set satisfies at least one predetermined criterion; and
transmit, via the communication interface, the persisted at least one data set and the information to a remote storage repository when the at least one predetermined criterion is satisfied.

13. The computing device of claim 12, wherein the at least one predetermined criterion includes at least one from among a motion detection criterion, a point of interest criterion, an object detection criterion, and a person detection criterion.

14. The computing device of claim 12, wherein the processor is further configured to:
inspect the persisted at least one data set to detect at least one error, the at least one error corresponding to at least one from among a corrupted data error, a distorted data error, and noisy data error; and
initiate at least one corrective action to resolve the detected at least one error, the at least one corrective action including at least one from among a filtering action, a deleting action, and a reconstructing action.

15. The computing device of claim 10, wherein the processor is further configured to:
receive, via a graphical user interface, at least one request from at least one authorized device, the at least one request including at least one textual command;
parse the at least one textual command to identify at least one requested data set that corresponds to the at least one textual command;
determine a storage location of the identified at least one requested data set; and
initiate a transmission of the identified at least one requested data set from the determined storage location to the at least one authorized device.

16. The computing device of claim 10, wherein the processor is further configured to receive the data from the at least one sensor device via at least one edge computing device that is locally operated together with the at least one sensor device.

17. The computing device of claim 16, wherein the at least one edge computing device includes a power source that enables operation of the at least one edge computing device without a connection to a power grid and an energy collector that replenishes the power source, the energy collector including at least one photo-voltaic module.

18. The computing device of claim 10, wherein, to generate the at least one data set, the processor is further configured to:
identify, from the data, metadata that corresponds to the generated at least one data set, the metadata including a current time and a current date; and
associate the metadata with the corresponding at least one data set.

19. A non-transitory computer readable storage medium storing instructions for facilitating jobsite monitoring, the storage medium comprising executable code which, when executed by a processor, causes the processor to:
receive data from at least one sensor device;
parse the data to generate at least one data set that corresponds to each of the at least one sensor device;
determine at least one threshold violation by comparing the at least one data set to a corresponding predetermined threshold value;
generate at least one alert based on a result of the determining, the at least one alert including information that corresponds to the at least one threshold violation;
identify at least one external device and at least one corresponding mobile communication protocol based on at least one from among a predetermined setting and the at least one threshold violation; and
transmit, via the at least one identified mobile communication protocol, the at least one alert to the at least one identified external device.

20. The storage medium of claim 19, wherein the data includes at least one from among motion data, temperature data, humidity data, gas dispersion data, image data, and video data that are captured by the at least one sensor device, the at least one sensor device including at least one from among a temperature sensor, a humidity sensor, a gas dispersion sensor, and an image sensor.
